(19) United States
(12) Patent Application Publication
(10) Pub. No.: US 2002/0133715 A1
(43) Pub. Date: Sep. 19, 2002

(54) Method for using a data processing system as a function of an authorization, associated data processing system and associated program

(76) Inventor: Giovanni Benini, Muenchen (DE)

Correspondence Address: BELL, BOYD & LLOYD, LLC, P. O. BOX 1135, CHICAGO, IL, 60690-1135, US

(21) Appl. No.: 10/006,314

(22) Filed: Dec. 4, 2001

(30) Foreign Application Priority Data
Dec. 4, 2000 (EP) 00126635.2

(51) Int. Cl. H04L 9/32

(52) U.S. Cl. 713/200; 707/513

(57) ABSTRACT

A method for using a data processing system as a function of an authorization, associated data processing system and associated program, wherein various authorization levels are defined for various user groups, a basic file contains the syntax for a basic authorization level, a priority file contains the syntax for a priority authorization level, the authorization level of a user is determined before the execution of the instructions of the user, and the basic file or the priority file is used, as a function of the authorization level, to define the instructions which the user is permitted to execute.

### BACKGROUND OF THE INVENTION

The present invention relates to a method in which a basic authorization level relating to the execution of specific instructions using the data processing system is defined for at least one basic user of a data processing system. A priority authorization level, which permits the execution of instructions with more wider ranging access rights in comparison to the instructions of the basic authorization level, is defined for at least one priority user of the data processing system. As a function of authorization level, a user can execute only the instructions defined for his/her authorization level.

Such a method is used, for example, to assign more access rights to a system administrator of the data processing system than to the other users. Thus, the system administrator can allocate passwords and access the memory units of the data processing system without restriction; for example, he/she is allowed to format the memory units. The other users only have very restricted access to the memory unit; for example, each user is allowed to use only a region of a memory unit which is specific to him/her.

However, authorization levels are used in many areas of data processing technology; for example, in the banking industry or when programming telephone features. Thus, in the article “Programming Internet Telephony Services”, J. Rosenberg, J. Lennox and H. Schulzrinne, IEEE Network, May/June 1999, page 42 to page 48, it is explained how various user groups can be assigned various authorization levels for programming telephone services. It is proposed that users with the priority authorization level can directly actuate a network gateway unit via an interface. This interface is referred to as a CG interface (Common Gateway Interface). For users with the basic authorization level it should be possible to carry out their services with a special call processing language. The language CPL (Call Processing Language) is used as the call processing language, such language being currently at a design stage (work in progress), see Draft-ietf-iptel-cply-*.txt at the web address www.ietf.org.

An object of the present invention is to disclose a simple method for using a data processing system as a function of an authorization, in which method, in particular, it is necessary to use as few programs as possible, and which method permits the instructions of an authorization level to be expanded and/or changed with little expenditure. In addition, an associated data processing system and an associated program will be disclosed.

### SUMMARY OF THE INVENTION

The present invention is based on the idea that hitherto the permitted instructions have been defined implicitly by the program commands of a program for executing the instructions. To date, it has not been possible to make a rapid change because changes have to be executed at a large number of points in the program. In the method according to the present invention, in addition to the method steps mentioned at the beginning, instructions for the basic authorization level are noted in a basic file section. Instructions for the priority authorization level are noted in a priority file section. The authorization level of a user is determined before the execution of the instructions of the user. The basic file section or the priority file section is used, as a function of the authorization level, to define the instructions which the user is allowed to execute.

The measures according to the present invention ensure that the definition of authorizations can be combined in various sections of a file or two different files. A file is a set of specific data which is stored under an identifier, for example under a specific file name, in the memory unit of a data processing system. Changes to the file sections can be executed easily. All that is necessary is to change file sections which are very short in comparison to the program which is required to execute instructions. As a result, the file which is to be changed is thus very easy to handle and the change can be executed quickly. Owing to the ease of handling, it is also the case that fewer faults occur than in the past when making changes. Furthermore, the recompilation of a program is dispensed with.

As an alternative to the instructions, the syntax of instructions is noted in the basic file section or in the priority file section. The syntax forms, on the one hand, the framework for permitted instructions. The syntax is mostly based on what is referred to as a “Bachus-Naur form” or on an expanded Bachus-Naur form. Conversely, the syntax defines, on the other hand, the production rules for fault-free programs. With the aid of using the syntax it is also possible to use a parser program to carry out checking of the instructions as a function of the authorization in a simple fashion. When the basic file section or the priority file section is changed or expanded, the syntax is changed or expanded.

In one embodiment, the basic file section and the priority file section are stored in different files; namely, in a basic file and in a priority file. The basic file and priority file refer below both to a file and to a file section.

In one embodiment of the method according to the present invention, all the instructions of the basic authorization level, and at least one additional instruction, are defined for the priority authorization level. Alternatively, or cumulatively, an expanded syntax in comparison with the syntax of the basic authorization level is defined for the priority authorization level. The instructions which are permitted for the priority authorization level thus form a superset which contains the instructions of the basic authorization level. This measure makes it possible to use the same program to execute the instructions for the basic authorization level and the priority authorization level. It is therefore not necessary to use a different program for each authorization level. This considerably reduces the expenditure for generating, documenting and maintaining the programs for executing the instructions.

In a further embodiment of the method according to the present invention, the authorization level is determined if a user transmits an instruction file with instructions to the data processing system. The instructions contained in the instruction file are checked as a function of the authorization level for this user, using the basic file or using the priority file. The instruction file is stored for a later execution only if it contains instructions which are valid for the authorization level determined. Otherwise, the instruction file is not stored and it is not possible for it to be executed later. The checking of the instruction file is, therefore, executed at a very early point in time. This point in time occurs before the point in time at which the instructions of the instruction file are executed; for example, several minutes, several seconds or several days. Instruction files which endanger the security of the data processing system are not stored for later execution. It is, therefore, not possible to execute such files.

The authorization level of the user can be determined cumulatively or alternatively to the checking before the storage, and also before the processing, of an instruction file. The basic file or the priority file is used to process the instruction file as a function of the authorization level for the processing of the application file. When there is cumulative determination of the authorization level, double security results.

In another embodiment of the method according to the present invention, the basic file and the priority file contain the syntax of instructions in a markup language. The markup language is used to describe contents of character chains. Markup languages can be read to the same degree by data processing systems and by operating personnel. The markup language SGML, see Standard ISO 8879:1986 Information Processing-Text and Office Systems-Standard Graphic Markup Language (SGML), the language XML (Extended Markup Language), see REC-xml-19980210 of the W3C (World Wide Web Consortium), the language HTML 4.0 or a language based on one of these languages is thus used. In particular, the languages XML and HTML are languages which a wide range of users is capable of using. In this embodiment, the application file contains instructions in the markup language; for example, instructions in XML. Markup languages generally use repetitions of the same key words in order to mark up text between the key words, i.e., describe its content. The key words are also referred to as tags.

Markup languages can be used to define instructions which control a voice transmission in a circuit-switched telephone network and/or in a packet-switched data transmission network. For this reason, in a further embodiment, the basic file and the priority file contain such instructions and/or the syntax of such instructions. This permits the users to easily program themselves features for a real-time voice transmission; i.e., for example, with processing times shorter than 250 ms from the recording of the voice data at the transmitter end to its outputting at the receiver end, using a markup language which is easy to learn and which they are already capable of using. Various instructions can be used as a function of the authorization level. For the basic authorization level, a call divert when specific events occur or feeding in of specific announcements is permitted, for example. In the priority authorization level, it is also possible, above and beyond the latter, to influence tolls. In one embodiment, the language used for the instructions is the abovementioned CPL (Call Processing Language). A language is thus used which is based on a markup language and is suitable, in particular, for programming features in a telephone network or features for Internet telephony. In this embodiment, the instruction file contains instructions for controlling the voice transmission.

In a further embodiment, the same parser program for decomposing the instruction file into individual instructions is used for processing the instruction file, irrespective of the authorization level. The same application program for executing the instructions is also used, cumulatively or alternatively, for processing the instruction file. In this way, despite various authorization levels, only two programs, which can be used to execute the instructions of the users with various authorization levels, are generated.

The present invention also relates to a data processing system and a program which permits the execution of the method according to the present invention or of one of the further developed embodiments. As a result, the abovementioned technical effects apply also to the data processing system and to the program.

Additional features and advantages of the present invention are described in, and will be apparent from, the following Detailed Description of the Invention and the Figures.

### BRIEF DESCRIPTION OF THE FIGURES

FIG. 1 shows functional units of a data processing system for whose users various authorization levels are defined.

FIG. 2 shows the interrelationship between the instructions of two different authorization levels.

FIGS. 3A and 3B show method steps during the reception of an XML file.

FIG. 4 shows the view of a telephone service.

### DETAILED DESCRIPTION OF THE INVENTION

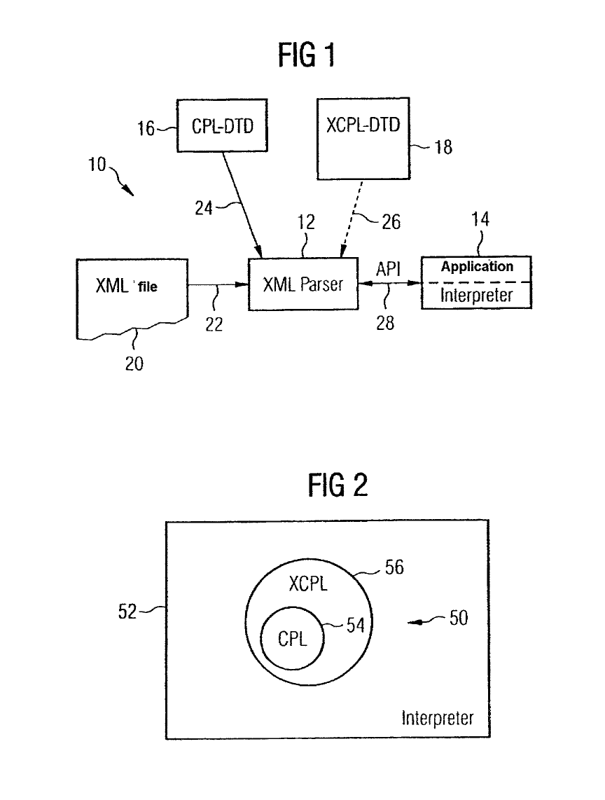

FIG. 1 shows functional units of a data processing system 10 for whose users various authorization levels are defined. The data processing system 10 contains a memory unit (not illustrated) and a processor (not illustrated) for executing program commands. A parser program 12, an application program 14, a basic definition file 16, a priority definition file 18 and an XML file 20 are stored in the memory unit of the data processing system 10.

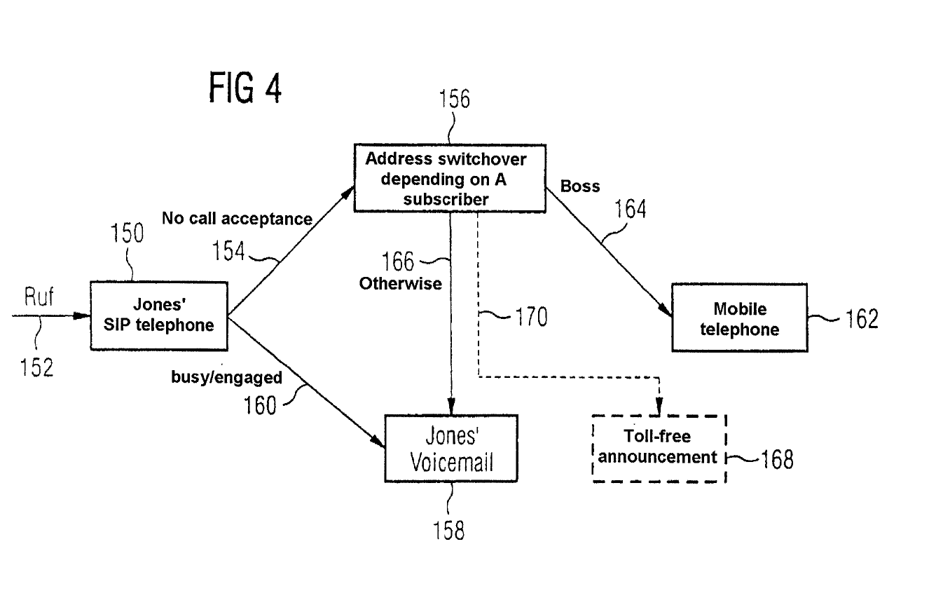

The parser program 12 is capable of separating from one another XML instructions contained in the XML file 20, see arrow 22. Here, as a function of the authorization level of a user who has generated the file 20, either the basic definition file 16 or the priority definition file 18 are used, see arrows 24 and 26. The basic definition file 16 is what is referred to as a DTD (Document Type Definition) file, as has been defined for the language XML. The basic definition file 16 contains the syntax of the language CPL (Call Processing Language). The priority definition file 18 is also a DTD file, but contains the syntax of a language XCPL (Extended CPL) which is extended in comparison with the language CPL. An example of such an extension is explained below with reference to FIG. 4.

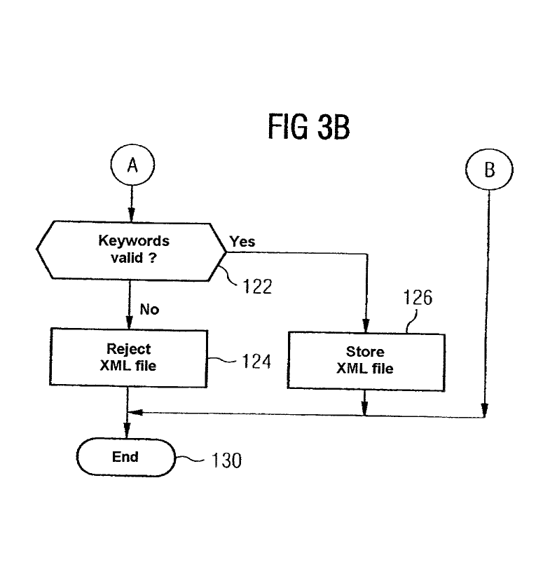

In addition, the parser program 12 is capable of checking the syntax of the XML file 20 using the basic definition file 16 or using the priority definition file 18, see also arrows 24 and 26. The steps carried out here are explained in more detail below with reference to FIGS. 3A and 3B.

The parser program 12 transfers, in the instruction execution mode, the individual instructions to the application program 14, see arrow 28. The interface between the parser program 12 and the application program 14 is predefined by the manufacturer of the parser program 12 and is referred to as an API (Application Programming Interface). The application program 14 can be used, depending on the instructions, to control functions of a switching office of the circuit-switched network or functions of network access units in a packet-switched network, for example functions of an EWSD (electronically controlled digital dialing system) switching office from SIEMENS AG. The Internet is used as a packet-switched network. The application program 14 contains an interpreter program for interpreting the individual instructions and for executing the functions defined for the instructions.

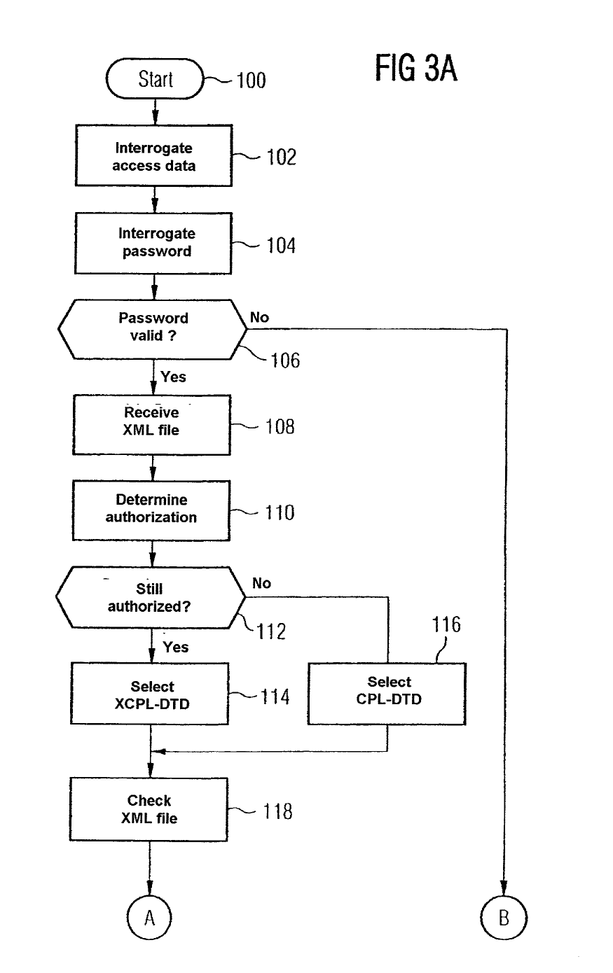

FIG. 2 shows a set diagram 50 of the instructions which can be executed by the interpreter 52 of the application program 14. The instructions of the language CPL can be executed by users with a basic authorization, see circle 54. Users with a priority authorization level can execute the instructions of the language CPL and additionally other instructions via which they can use extended access rights; for example, to memory units, see circle 56. The instructions of the language XCPL thus form a superset which contains the instructions of the language CPL as a subset.

FIGS. 3A and 3B show method steps which are executed during the reception of the XML file 20 in the data processing system 10, see FIG. 1. The method starts at a method step 100 after which the files or programs explained with reference to FIG. 1, with the exception of the file 20, have been stored in the data processing system 10. In addition, authorization levels for various user groups have been defined. The basic definition file 16 applies for a basic authorization level. The priority definition file 18, which permits a set of instructions which is extended in comparison with the basic authorization level, applies to a priority authorization level.

In a method step 102 which follows the method step 100, the access data of the user who wishes to transmit the file are interrogated. The access data include, for example, a user name.

In a method step 104, a password which is treated as confidential by the users of the data processing system 10 is interrogated. The received password is used to check whether this password is valid for the user name received in the method step 102, see method step 106. If the password is valid, in a method step 108 the file 20 is transmitted and buffered in the working memory of the data processing system 10. In a subsequent method step 110, the authorization level, i.e. the basic authorization level or the priority authorization level, for the user from which the file 20 came is determined.

In a method step 112 it is checked whether the user has the priority authorization level. If this is the case, the priority definition file 18 is selected for a following parser pass, see method step 114. On the other hand, if the authorization level determined in the method step 110 is the basic authorization level, the basic definition file 16 is selected for the following parser pass in a method step 116 which directly follows the method step 112.

In a method step 118, the file 20 is parsed via the parser program 12 using the definition file selected in the method step 114 or 116. For the time being, the instructions contained in the file 20 are not executed.

In a method step 122 it is checked whether all the keywords contained in the file 20 are permitted in terms of the syntax of the definition file selected in the method step 114 or in the method step 116. If there are invalid keywords, the file 20 is rejected in a method step 124. For example, other data are written over the data of the file 20 in the data processing system 10. If, on the other hand, all the keywords are valid, it must be assumed that the user of the file 20 is using only instructions which are permitted for his/her authorization level. For this reason, in a method step 126, the file 20 is stored for later processing in a non-volatile memory of the data processing system 10. Alternatively or cumulatively, the file 20 is immediately executed or processed.

Directly after the method step 124 or after the method step 126, the method is terminated in a method step 130. The method step 130 is also executed directly after the method step 106 if it is determined that the password which has been input is invalid.

FIG. 4 shows the view of a telephone service. A user or subscriber with the name Jones programs this service using the language XML and specifically the language CPL. The user or subscriber Jones has a SIP telephone 150 which operates according to the SIP (Session Initiation Protocol) standard. This protocol has been defined by the IETF as a standard for IP (Internet Protocol) telephony in the RFC (Request for Comment) 2543. When there is an incoming call 152 for the telephone 150 at a switching office or at a network access unit, various functions are to be activated as a function of the busy/idle status of the telephone 150. If Jones does not answer the telephone 150, see arrow 154, an address switchover function 156 is to be used. If, on the other hand, the telephone 150 is busy because Jones is making a call at that time, the incoming call 152 is redirected to a telephone answering machine 158, see arrow 160.

When the address switchover function 156 is executed, the origin of the incoming call 152 is to be taken into account. If the calling subscriber, i.e. the A subscriber, is Jones' superior, the incoming call is diverted to Jones' mobile phone 162, see arrow 164. If, on the other hand, the call 152 is not from Jones' superior, the incoming call is to be diverted to the telephone answering machine 158, see arrow 166.

The CPL source text for programming this function is as follows:

```
<?xml version=“1.0” ?>
<!DOCTYPE cpl PUBLIC “−//IETF//DTD RFCxxxx CPL 1.0//EN”
“cpl.dtd”>
<cpl>
  <subaction id=“voicemail”>
  <location url=“sip:jones@voicemail.example.com”>
    <redirect />
  </location>
  </subaction>
  <incoming>
  <location url=“sip:jones@phone.example.com”>
    <proxy timeout=“8”>
    <busy>
      <sub ref=“voicemail” />
    </busy>
    <noanswer>
      <address-switch field=“origin”>
      <address contains=“boss@example.com”>
        <location url=“tel:+19175551212”>
        <proxy />
        </location>
      </address>
      <otherwise>
        <sub ref=“voicemail” />
      </otherwise>
      </address-switch>
    </noanswer>
    </proxy>
  </location>
  </incoming>
</cpl>
```

This source text can be found in the draft (work in progress) “CPL: Language for User Control of Internet Telephony Services”, by Lennox/Schulzrinne. This draft can be called up on the web page with the address www.ietf.org under the name “Draft-ietf-iptel-cpl-02.txt”. In particular, reference is made to FIG. 24 of the draft and to the associated explanations.

The source text contains commands which are contained in the basic definition file 16. The content of the basic definition file 16 can also be called up in the draft for the language CPL at the given address.

On the other hand, a user for which the priority authorization level has been defined is allowed to use instructions which have been defined in the priority definition file 18. The syntax of the language CPL is therefore extended as follows, for example:

<!-- Extended action nodes -->
<!ENTITY % ExtendedAction ‘billing|database-
query|announcement’ >

| | |
|---|---|
| <!ENTITY % Node | ‘(%Location;\|%Switch;\|%SignallingAction;\| |
| | %ExtendedAction;\|%OtherAction;\|%Sub;)?’ |

>

An additional syntax element “ExtendedAction” is defined for the extended language XCPL, which additional syntax element can relate to the billing, to a database query or to an announcement. The syntax for the syntax element “node” has been extended. It is then possible also to refer to the “ExtendedAction” syntax element. In addition, the syntax has been supplemented as follows:

<!ELEMENT billing ( %Node; ) >
<!ATTLIST billing

| | |
|---|---|
| switch | (on\|off) “on” |

>
<!ELEMENT database-query ( %Node; ) >
<!ATTLIST database-query

| | | |
|---|---|---|
| database | CDATA | #REQUIRED |
| baseobject | CDATA | #REQUIRED |
| search-key | CDATA | #REQUIRED |

| | |
|---|---|
| scope | (baseObject\|singleLevel\|wholeSubtree) “ba- |

seObject”

| | | |
|---|---|---|
| attributes | CDATA | #REQUIRED |
| result | CDATA | #REQUIRED |

>
<!-- the attribute list is thought only as simple example -->
<!ELEMENT announcement ( %Node; ) >
<!ATTLIST announcement

| | | |
|---|---|---|
| audiofile | CDATA | #REQUIRED |

>

The billing can, thus, be switched on and off. In the case of a database inquiry, a name of the database, a reference object, a search key and further parameters are to be specified. The announcement is defined as an audio file.

Furthermore, the syntax of the priority definition file 18 corresponds to the syntax of the basic definition file 16.

The user with the priority authorization level would like, for example, the address switchover function 156 to operate in a somewhat modified way. If the call 152 comes from his/her superior, a call divert is still to be made to the mobile phone 162, see arrow 164. On the other hand, if the call comes from another subscriber, the calling subscriber is to be able to listen to a toll-free announcement 168, see arrow 170. The function indicated by the arrow 166 is thus not necessary. The XML text of the file 20 for the user or subscriber with the priority reference level is as follows:

```
<?xml version=“1.0” ?>
<!DOCTYPE cpl PUBLIC “−//IETF//DTD RFCxxxx CPL 1.0//EN”
“xcpl.dtd”>
<cpl>
  <subaction id=“voicemail”>
  <location url=“sip:jones@voicemail.example.com”>
    <redirect />
  </location>
  </subaction>
  <incoming>
  <location url=“sip:jones@phone.example.com”>
    <proxy timeout=“8”>
    <busy>
      <sub ref=“voicemail” />
    </busy>
    <noanswer>
      <address-switch field=“origin”>
      <address contains=“boss@example.com”>
        <location url=“tel:+19175551212”>
        <proxy />
        </location>
      </address>
      <otherwise>
        <billing switch=“off”>
        <database-query
          database=“C:\Data\wav.dc”
          baseobject=“jonesdata”
          search-key=“announcements”
          attributes=“not_available”
          result=“temp.wav”
        >
          <announcement audiofile=“temp.wav”>
          </announcement>
        </database-query>
        </billing>
      </otherwise>
      </address-switch>
    </noanswer>
        </proxy>
      </location>
      </incoming>
    </cpl>
```

This source text corresponds in large parts to the source text illustrated in the draft relating to the language CPL, FIG. 24, and explained above. However, there are differences within the <otherwise>. . . </otherwise>tag. The billing is switched off within this tag. Then, the instruction “database query” is used to make a database query to determine a voice file “temp.wav”. Then, this file is played using the instruction “Announcement”.

Although the present invention has been described with referenced to specific embodiments, those of skill in the art will recognize that changes may be made thereto without departing from the spirit and scope of the invention as set forth in the hereafter appended claims.

1. A method for using a data processing system as a function of an authorization, the method comprising the steps of:
defining a basic authorization level relating to execution of specific instructions using the data processing system for at least one basic user of the data processing system;
defining a priority authorization level, which permits execution of instructions with wider ranging access rights in comparison to the instructions of the basic authorization level, for at least one priority user of the data processing system;
noting at least one of the instructions and a syntax of the instructions for the basic authorization level in a basic file section;
noting at least one of the instructions and a syntax of the instructions for the priority authorization level in a priority file section;
determining the authorization level of a user before the execution of the instructions of the user; and
using one of the basic file section and the priority file section, as a function of the authorization levels determined, to define the instructions which the user can execute.

2. A method for using a data processing system as a function of an authorization as claimed in claim 1, the method further comprising the steps of:
storing the basic file section in a basic file; and
storing the preferred file section in a priority file, which differs from the basic file.

3. A method for using a data processing system as a function of an authorization as claimed in claim 1, wherein at least one of the basic file section and the priority file section does not itself define a program or program section which can be executed by a processor.

4. A method for using a data processing system as a function of an authorization as claimed in claim 1, the method further comprising the step of:
defining the instructions of the basic authorization level and at least one of an additional instruction and an expanded syntax in comparison with the syntax of the basic authorization level for the priority authorization level.

5. A method for using a data processing system as a function of an authorization as claimed in claim 1, the method further comprising the steps of:
transmitting, by a user, an instruction file with instructions to the data processing system for determining the authorization level;
checking the instructions contained in the instruction file as a function of the authorization level using one of the basic file section and the priority file section; and
storing the instruction file for a later execution if it contains only instructions which are valid for the authorization level which is determined.

6. A method for using a data processing system as a function of an authorization as claimed in claim 5, the method further comprising the steps of:
determining the authorization level of the user before the processing of the instruction file; and
using one of the basic file section and the priority file section to process the instruction file as a function of the authorization level for the processing of the instruction file.

7. A method for using a data processing system as a function of an authorization as claimed in claim 5, wherein the basic file section and the priority file section contain at least one of instructions and a syntax of the instructions of a markup language, which is used to described contents of character chains, the markup language being selected from the group consisting of SGML, XML, HTML 4.0, and a markup language based on one of these languages, such that the instruction file contains instructions in the markup language.

8. A method for using a data processing system as a function of an authorization as claimed in claim 5, wherein the basic file section in the priority file section define at least one of instructions and a syntax of the instructions for controlling a voice transmission via at least one of a circuit-switched telephone network and a packet-switched data transmission network, the syntax of instructions of a language selected from a group consisting of CPL and a language based on CPL, such that the instruction filed defines instructions for controlling the voice transmission.

9. A method for using a data processing system as a function of an authorization as claimed in claim 5, wherein, for processing the instruction file, a same parser program is used for decomposing the instruction file into individual instructions.

10. A method for using a data processing system as a function of an authorization as claimed in claim 5, wherein a same application program is used for executing the instructions, irrespective of the authorization level.

11. A data processing system which is used as a function of an authorization, comprising:
a part for defining a basic authorization level relating to execution of specific instructions using the data processing system for at least one basic user of the data processing system;
a part for defining a priority authorization level, which permits execution of instructions with wider ranging access rights in comparison to the instructions of the basic authorization level, for at least one priority user of the data processing system;
a part for noting at least one of the instructions and a syntax of the instructions for the basic authorization level in a basic file section;
a part for noting at least one of the instructions and a syntax of the instructions for the priority authorization level in a priority file section;
a part for determining the authorization level of a user before the execution of the instructions of the user; and
a part for using one of the basic file section and the priority file section, as a function of the authorization level determined, to define the instructions which the user can execute.

12. A program having a command sequence during whose execution a method for using data processing system as a function of an authorization is executed by a processor, comprising:
a section for defining a basic authorization level relating to execution of specific instructions using the data processing system for at least one basic user of the data processing system;
a section for defining a priority authorization level, which permits execution of instructions with wider ranging access rights in comparison to the instructions of the basic authorization level, for at least one priority user of the data processing system;
a section for noting at least one of the instructions and a syntax of the instructions for the basic authorization level in a basic file section;
a section for noting at least one of the instructions and a syntax of the instructions for the priority authorization level in a priority file section;
a section for determining the authorization level of a user before the execution of the instructions of the user; and
a section for using one of the basic file section and the priority file section, as a function of the authorization levels determined, to define the instructions which the user can execute.
